(19) United States
(12) Patent Application Publication
(10) Pub. No.: US 2005/0030588 A1
(43) Pub. Date: Feb. 10, 2005

(54) Methods and apparatus utilizing embedded data layers

(76) Inventors: Curtis Reese, Boise, ID (US); John R. Hatten, Boise, ID (US); Brett A. Green, Meridian, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/635,819

(22) Filed: Aug. 6, 2003

(51) Int. Cl. G06K 15/02; G06F 17/60; G06F 17/30

(52) U.S. Cl. 358/3.28; 707/104.1; 705/1; 715/902; 715/911

(57) ABSTRACT

Methods and apparatus are described for utilizing embedded data layers in images. In one embodiment, an image database stores and controls images and/or image objects and their associated information metadata layers, which allows for multiple levels of data to be retrieved and encoded into the image. This increases image data content and information in a manner that will not be separated from the image through their embedding in multiple transform or high coding rate watermarks, incorporating the multiple metadata data fields in the selected image or selected image objects. The various embodiments include databases that allow images or sub-images/objects and information associated with the image or object to be easily associated and assembled as needed or produced on demand. In one embodiment, a manufacturer generates a database of product images and associated product information.

### FIELD OF THE INVENTION

The present invention relates generally to methods and apparatus utilizing image data layer embedding.

### BACKGROUND

Images or text (referred to herein as images) are typically formed in modern systems by generating and displaying the component pixels of the image. With modern printing devices, such as, but not limited to, industrial printers, plotters, facsimile machines, laser printers, or ink jet printers (referred to herein collectively as printers), this image is typically formed on a print medium by the placement of pixels on the print medium with one or more printing toners, inks, or transfer/donor materials from a print ribbon (for example, plastic tape based label maker). Alternatively the pixels of the image can be brought out of the print medium itself by exposing it to a chemical, heat, or light based process in the varying strengths and patterns of the pixels of desired image (for example, thermal printers, photographic films, lithography, and etching).

Multiple methods of coding information into the pixels of images in manners that minimally change the underlying image and how it is perceived by human viewing exist and are generally referred to as steganography and/or watermarking (referred to herein as watermarking). Watermarking of images has been generally used for cryptography, security/authenticity of an image, rights management, tamper-proofing an image, and for proof of origin of an image.

The coding rate of a watermark, the relative amount of secret information that can be reliably embedded in the image, typically involves a tradeoff with visual quality and robustness. A higher coding rate allows more information to be embedded in the image, but tends to reduce the visual quality of the image and robustness in decoding the message. Conversely, a lower coding rate tends to provide less information, but the image has a higher visual quality and the decoding is more robust. Because of the image quality and robustness issues watermarking has typically been utilized to encode a small amount of data into an image with a lower coding rate. Watermarking also typically encoded the image as a whole to improve image quality, robustness, and data content by utilizing as large an image area as possible. As stated above, it is desirable, however, to perform hardcopy watermarking that is robust, has a high coding rate, and yet has a high visual quality to the resulting image. Several new methods of watermarking have been allowing for these qualities. One such method of watermark encoding that has a high coding rate, while being generally robust and having a high visual quality, and yet can be used in multiple transform domains, is described in United States Patent Application Pub. No. US 2002/0176599, published Nov. 28, 2002, titled “Hardcopy Watermarking”, by Levy et al., which is commonly assigned.

In many situations there is information or data that is associated with an image or one or more elements in an image. For example, an image or one or more of its elements could be associated with date, location, or other descriptive information. In advertising or in other commercial images this associated information typically includes the commercial details or various specifications of the pictured subject; for example, contact information, size, availability, and/or prices.

A problem with this image information or image “metadata” is that it is typically not permanently associated with the image. As a result the metadata can be lost or, in the case of advertising or commercial images, not readily available for reference or presentation when the image is used or shown. This is particularly a problem with advertising or commercial images in that in many cases the image or resulting print medium is composed of multiple sub-images that can come from different sources and/or vendors. Additionally, text space or alternative print/presentation space on the print medium is typically at a premium and not all of the associated information may be able to be printed, or if it is printed is not directly associated with the image or sub-image it refers to and therefore may be misinterpreted by the reader. Furthermore, as stated above, it is often desired to associate multiple different types of common information in differing information fields (such as date, title, location, subject matter, etc.) with a given image or with each image of a set of images. This is particularly the case in advertising or commercial images where documents or advertising flyers are composed for specific purposes by the advertiser retrieving the images from ready repositories or databases of images they have at hand. The associated advertising or commercial information content of the images may also vary depending on promotions, sales, region, presenter, vendor and/or the identity of the advertiser themselves. As the associated image information may come from multiple vendors and may not be directly linked with the images, and/or the advertisement may not have the space available to include the associated information the information may easily get dropped from the advertisement, inadvertently placed with the wrong image, placed with the wrong promotion, and/or misinterpreted by the consumer.

For the reasons stated above, and for other reasons stated below that will become apparent to those skilled in the art upon reading and understanding the present specification, there is a need in the art for an improved method for vendors associating and embedding information with images, and in particular for providing this information to advertisers.

### SUMMARY

The various embodiments described herein facilitate various methods and apparatus for utilizing embedded data layers in images. One embodiment includes databases or repositories of images and their associated information for steganographic embedding or watermarking of multiple data fields or data layers (image metadata) in an image or in one or more of the sub-images/objects (the component images of the overall image, referred to herein as image objects). The databases allow images or sub-images/objects and their associated information to be easily linked and then retrieved on demand or assembled as needed. In another embodiment, a manufacturer generates a database or repository of product images and associated product information. In another embodiment, a repository or database of images and associated information is accessed over a network. In yet another embodiment, the database or repository is distributed by the database producer and is accessed locally by the advertiser/printer/publisher. In another embodiment, a database includes images with two or more data fields for embedding into two or more watermarks of differing encoding or within the same watermark at a high coding rate. In addition, in other embodiments, a database includes two or more data fields for embedding within one or more sub-images/objects of an image. Methods and apparatus are also included for encoding and decoding the multiple data fields.

Embodiments of the present invention allow for the advantages of storing multiple layers of associated data with an image or with each sub-image and then embedding them in the final printed page. This allows this information, which would not otherwise be available, to be retrieved by an end-user with a watermark enabled scanner or image reader (herein referred to as a reader). Additionally, embodiments of the present invention allow the association of multiple layers of data directly with an image or sub-image under control of the image/sub-image creator, allowing the data to be specific and contextual to the image/image object within a document, reducing the potential for reader/audience misunderstanding, improving communication, and in a commercial publication, improving the marketing effectiveness of advertising efforts. Furthermore, embodiments of the present invention enable advertisers to sell more advertising for a given space of advertising and/or for manufacturers to share advertising costs and control advertising information and/or product alternatives/substitution information associated with their products.

Embodiments of the invention include apparatus and methods of varying scope.

### DESCRIPTION OF THE DRAWINGS

FIG. 1 is a simplified diagram of an image and data layers in accordance with an embodiment of the present invention.

FIG. 2 is a simplified diagram of an image with multiple image objects and data layers in accordance with another embodiment of the present invention.

FIG. 3 is a simplified diagram of an image database/repository with multiple data layers in accordance with another embodiment of the present invention.

### DETAILED DESCRIPTION

In the following detailed description of the present embodiments, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that process, electrical or mechanical changes may be made without departing from the scope of the present invention. The following detailed description is, therefore, not to be taken in a limiting sense, and the scope of the present invention is defined only by the appended claims and equivalents thereof.

Embodiments of the present invention facilitate various methods and apparatus for utilizing embedded data layers in images. One embodiment of the present invention utilizes image databases or repositories to store and control images and/or image objects and their associated information metadata layers until their use in multiple transform or high coding rate watermarks, embedding the multiple metadata data fields in the selected image or selected objects (the component images). Embodiments include databases that allow images or image objects and their associated information to be easily linked and then retrieved on demand or assembled as needed. In one embodiment, a manufacturer generates a database or repository of product images and associated product information. In another embodiment, a repository or database of images and associated information is accessed over a network. In yet another embodiment, the database or repository is distributed by the database producer and is accessed locally by the advertiser/printer/publisher. In another embodiment, a database includes images with two or more data fields for embedding into two or more watermarks of differing encoding or within the same watermark at a high coding rate. In addition, in other embodiments, a database includes two or more data fields for embedding within one or more sub-images/objects of an image. Methods and apparatus are also included for encoding and decoding the multiple data fields.

Embodiments of the present invention also allow for the advantages of storing multiple layers of associated data with an image or with each sub-image and then embedding them in the final printed page. This allows this information, which would not otherwise be available, to be retrieved by an end-user with a watermark enabled scanner or image reader (herein referred to as a reader). Additionally, embodiments of the present invention allow the association of multiple layers of data directly with an image or sub-image under control of the image/image object creator, allowing the data to be specific and contextual to the image/image object within a document, reducing the potential for reader/audience misunderstanding, improving communication, and in a commercial publication, improving the marketing effectiveness of advertising efforts. Furthermore, embodiments of the present invention enable advertisers to sell more advertising for a given space of advertising and/or for manufacturers to share advertising costs and control advertising information and/or product alternatives/substitution information associated with their products.

As stated above, steganography and watermarking are methods of encoding information into the pixels of images in manners that are robust and have a high resulting image quality. Prior art watermarking typically encodes only a small amount of data in a single layer of watermark encoding at a low coding rate in an image to preserve the image quality and robustness of the encoded data (the ability to retrieve the encoded data). This watermark is also generally encoded in the image as a whole. In addition, the use of watermarking in images and, in particular, printed material has suffered from issues of reliability in that they may be easily damaged and rendered unreadable. Newer systems of watermarking allow for high coding levels and increased robustness, while maintaining a high level of image quality. As described in the U.S. patent application Ser. No. ______ (HP Patent Application Ref. No. 200206812-1), titled “Embedded Data Layers”, which is commonly assigned, this allows for the encoding of multiple layers of data/data fields into a given image or into objects within a given image utilizing multiple watermarking methods that utilize differing transforms and/or encoding methods or within a single watermark when the watermark allows for a high coding level. This watermarking of multiple data levels, enabling storage of two or more data levels in a given image or image object in a printed page, allows for image information/associated information/metadata to be embedded and permanently associated with the image. Watermarking of image objects allows multiple levels of metadata to be provided for multiple arbitrary objects in a page and not just the entire page, allowing the information to be relevant to the scanned object and readily available for reference.

In the past advertisers and/or publishers (referred to herein as advertisers) have composed advertisements or publications for specific purposes utilizing stock images supplied by the vendor or manufacturer (referred to herein as vendors) or generated by themselves internally. Coordinating the information that is to be associated with each item/image for the specific vendor, manufacturer, and/or promotion and placing that information within the advertisement (while minimizing the size of the advertisement to reduce costs) has been a non-trivial task. In addition, this associated item/image information typically does not come in a uniform format and often must be specially handled by the advertiser.

In the case of advertising or commercial images, embedding of multiple data levels in the image or objects of the image allows the related product information to be readily available for reference or presentation through use of a watermark enabled reader or viewer when the image is used or shown.

Embodiments of the present invention include organized image repositories and/or image databases (referred to herein collectively as image databases) to aid in sourcing and/or managing the stock images and the associated information layers that are provided by the vendor. In one embodiment, the image database is active and allows the database to be queried for the desired image or image object. In another embodiment, the images or objects and their associated metadata layers can be retrieved or assembled/associated as needed based on the advertiser, the geographic region, the promotion, the selected products, and/or language of the advertisement and its intended audience. In another embodiment, the images or image objects and their associated metadata layers are stored in a uniform format, allowing for uniform and automated handling of the images and information by the database creator and the image end-user (the vendor and the advertiser respectively). This allows the images or image objects and their associated information of to be controlled by the vendor, easily provided to and utilized by the advertiser, and customized as needed.

This ability to control the images and their associated information is advantageous for advertising or other commercial images. In many cases in advertising the image or resulting print medium is often composed as a composite of multiple images or sub-images that can come from many different image sources (internal and external to the advertiser), stock images, manufacturers, and/or vendors. Embodiments of the present invention allow each image or image object to have differing information associated with it that will be included in the advertisement or is relevant to the image/image object. The advertising or commercial associated information content may not be static for each image/image object and can vary depending on promotions, sales, region, presenter, vendor and/or advertiser. Additionally, text space or alternative print/presentation space on the print medium is typically limited and/or costly to the advertiser and/or specific vendor and not all of the associated information may be able to be printed, or if it is printed it is not directly associated with the image or sub-image it refers to and may therefore be misinterpreted by the reader.

Consumers can now obtain specific information about each item in the publication and/or advertisement with a watermark enabled reader or scanner. This information could include, but is not limited to, the vendor's universal resource locator (URL), the specific item title and/or description, catalog number and/or page number, sizes available, colors available, and price. The vendor has the benefit of being able to provide the advertising image/image object and the detailed information on the item, whether the detailed information is printed directly on the page or not. This allows the vendor to control the image and the details associated with the image and to directly or indirectly promote their product themselves within the advertisement or publication.

The vendor also has the benefit of being able to pre-generate and proof multiple versions of the image and its associated information, store them in the image database, and provide them to the advertiser(s) whenever the advertisement is designed. The image/image object and associated information, in one embodiment, can also be auto-generated by the image database for the specific advertising criteria on demand. The storage of the images/image objects and their associated information in an image database also allows for ease of maintaining this information and the images, allowing the images and/or associated information (such as description, prices, colors, sized, etc.) to be easily updated, where in the past such would require detailed coordination between the vendor and the advertisers.

In one embodiment of the present invention, the watermark metadata layers also allow for the embedding of alternative product information in the item's image. For example, this alternative product information can be in the form of alternative sizes, colors, and/or product features. Alternatively, the alternative product information could also include product substitutions of matching products/product substitutions from an alternative vendor/item source. In addition, item accessories and/or complementary products can be listed in the watermarked image of the item. This alternative product/substitution information increases the promotion of lines of products to the consumer within a single image without increasing the page size, the image appearance, or the advertisement base price.

In another embodiment of the present invention, the embedded layers of metadata in the images of an advertisement page assembled from an image database allows advertisers to increase the number of retailers/clients which can be promoted in a given advertisement page, potentially increasing advertising revenue. The supporting items in a given advertisement page, that are not the main subject of the advertisement, can now be promoted to the consumer who has access to a watermark enabled reader. For example, a car advertisement for showing a convertible at a resort can now also advertise the fly-fishing rod in the car, the resort, the clothes that the model is wearing, and the agent information for the model themselves.

In another embodiment of the present invention, the embedded layers of metadata in the images of an advertisement page assembled from an image database can also allow teams of vendors to share or mitigate the costs of a publication or an advertisement in an advertisement or commercial publication, such as a newspaper or magazine. For example, differing manufacturers could pay for a given advertisement or commercial publication based on such factors as the prominence of their product (being the primary subject or a supporting item of the advertisement) or based on the space that the product consumes on the printed page.

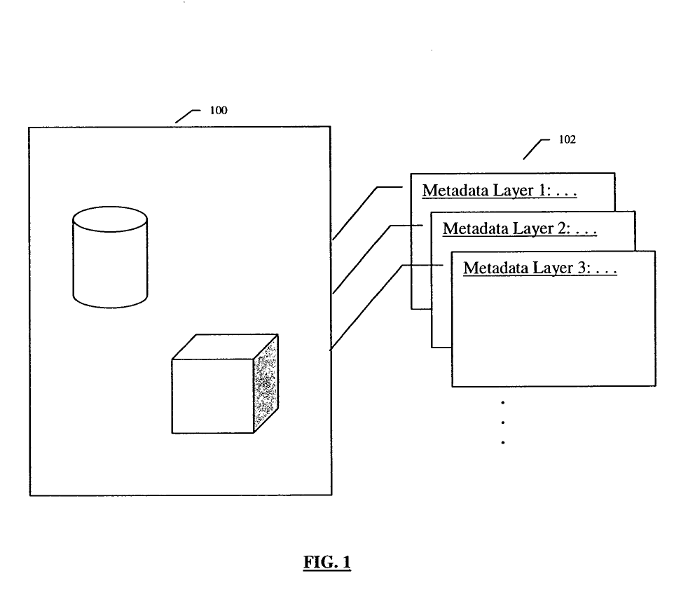

FIG. 1 is a simplified diagram of an image 100 as utilized with an embodiment of the present invention. In FIG. 1, the image 100 contains one or more graphical sub-elements or objects 104 (referred to herein as objects). Embedded into the image 100 is a watermark (not shown) that contains one or more layers of metadata 102 encoded into a composite watermark made up of multiple sub-watermarks of differing transforms/encodings or within a single watermark of a high coding rate, where the number of multiple watermarks or coding rate of the single watermark are configured to be large enough to encode the number and amount of data in the defined metadata layers. Each layer of metadata 102 can contain one or more data values or data areas. The metadata 102 stored in the watermark is accessible by a user through use of a watermark enabled reader.

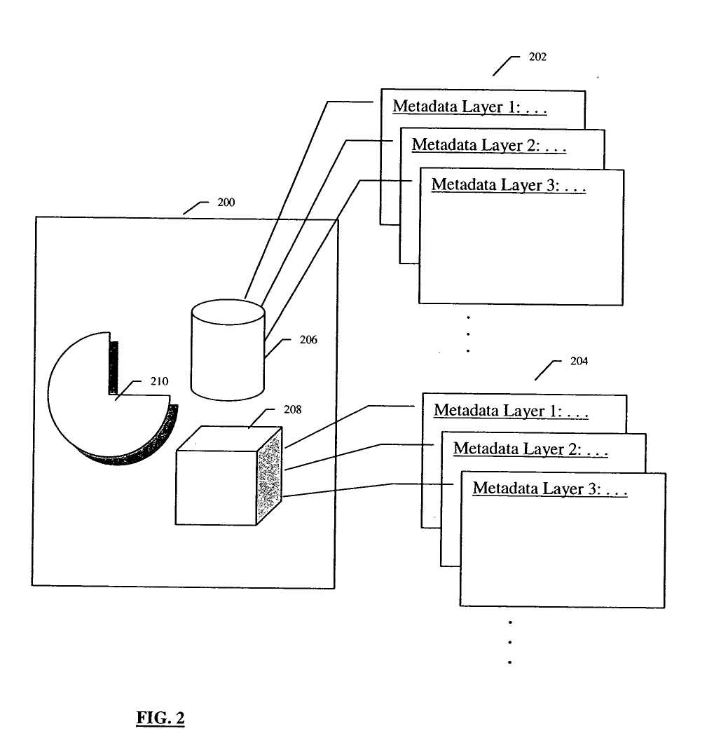

FIG. 2 is a simplified diagram of an image 200 as utilized with an embodiment of the present invention having one or more image objects that contain watermarks. In FIG. 2, the image 200 contains one or more graphical image objects 206, 208, and 210. Selected image objects 206, 208 each contain an embedded watermark (not shown) that each contains two or more layers of metadata 202, 204 encoded into a composite watermark made up of multiple sub-watermarks of differing transforms/encodings or within a single watermark of a high coding rate. The image objects 206, 208 that contain embedded watermarks can be arbitrarily selected and/or defined in the image 200 by the advertiser. Each layer of metadata 202, 204 can contain one or more data values or data areas. The metadata layers of each watermarked object 206, 208 in the image 200 are accessible by a user by scanning the object with a watermark enabled reader to read the data layers embedded in their watermark. It is noted that the image 200 of FIG. 2 has multiple levels of metadata provided for multiple arbitrary objects in its page and not only just for the entire page.

Users may select which of the metadata layers of the images 100, 200 illustrated in FIGS. 1 and 2 to view after accessing them with a watermark enabled reader. Alternatively, readers or reader software may be configured to show or not show a given layer to the user, or only those layers accessed by them with the appropriate code/personal identification number (PIN). Additionally, in some embodiments, the information contained in the metadata layers may be used by the reader software to activate further processes, including, but not limited to, accessing the internet, accessing a database, accessing a program, enabling execution of an application or access to a computer system, and decoding encrypted content. In another embodiment of the present invention, the metadata layers are selected based on the geographic location/locale of the reader. The geographic location information can be entered into the reader by the user or inferred from time zone and/or language selection the reader or the computer the reader operates under is configured with. In one embodiment, the geographic information is retrieved from an attached global positioning sensor (GPS). In another embodiment, the geographic location/locale information is used as an input along with the metadata layers by the reader software to activate further processes, including, but not limited to, accessing the internet, accessing a database, accessing a program, or enabling execution of an application or access to a computer system.

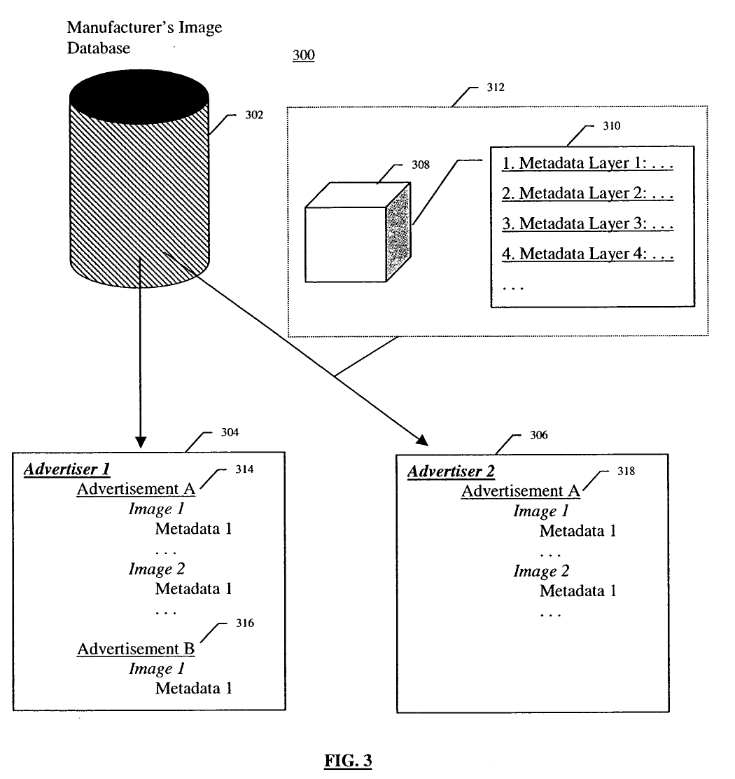

FIG. 3 is a simplified diagram of an image database or repository 300 of an embodiment of the present invention containing one or more images or image objects and their associated layers of information/metadata for eventual use in printed media, commercial literature, and/or advertisements. In FIG. 3, the manufacturer's image database 302 contains one or more graphical images or objects and their associated metadata layers (not shown). Advertisers/image requesters 304, 306 access the image database 302 and retrieve 312 one or more images or image objects 308 and their associated metadata layers 310 for use in printed advertisements and/or publications 314, 316, 318.

The image database 302 can contain pre-generated and proofed versions of the images/image objects and associated information, or the images/image objects and associated information can be dynamically generated by the image database 302 for the specific advertiser 304, 306 and/or geographical region/promotion/etc. The auto-generation of images and specific metadata layers is on demand based on the query input and/or requesting advertiser characteristics (including, but not limited to, advertiser, location/country/state of distribution, business relationship with image producer, special promotions/promotion type, and language). The storage of the images/image objects and their associated information in the image database 302 also allows for ease of updating and maintaining the associated metadata information and images/image objects. The advertiser 304, 306 can access the image database 302 either across a network from the vendor or locally from a local copy of the image database 302 that can be maintained by the vendor.

In other embodiments of the present invention, the multiple layers of metadata in a given object or image contain standardized data types in each different level. For one embodiment the data layers for an advertising oriented image or object are defined as follows: Layer One—Manufacturer specific information (such as, company name, business contact information, universal resource locator (URL), etc.), Layer Two—Object Characteristics (name, price, sizes available, colors available, etc.), Layer Three—Order information (catalog number, catalog page, matching accessories, substitutes if unavailable, retail locations, etc.), Layer Four—Manufacturer designated information (miscellaneous data included by the manufacturer).

To print from a client application to a multiple layer watermarking enabled printer, the client applications would utilize a printer driver that is modified to generate a page description language (PDL) with extensions that would incorporate the metadata into the PDL data stream. The client application would print the image incorporating the defined objects and one or more of the associated metadata data layers (as optionally selected by the user and/or program) through the printer driver. The printer driver would generate a page description in a PDL, such as, but not limited to, PCL5, PCL6, or Postscript, and within the PDL page descriptions incorporate the defined metadata. Objects would be defined and transmitted to the multiple layer watermarking enabled printer in a raster or vector definition and the object definition in the PDL would include the metadata to be associated with the object in the final printed page. The multiple layer watermarking enabled printer would then generate the image and its objects from the PDL definition and embed each associated metadata layer within each defined object or page in a multiple layer watermark in that object or page image. Alternatively, the printer driver would itself embed each associated metadata layer within each defined object or page in a multiple layer watermark. In doing so the printer driver would generate a page description in a PDL that included the images or objects with embedded metadata layers in a pre-generated raster scan. The resulting page description could then be printed on any printer with the requisite PDL interpreter, inks, and printing resolution.

In one embodiment, the images and image objects and some or all of their associated metadata layers of a print job is logged by a printer. In another embodiment, the size of each logged image/image object on the page it is printed on is logged by the printer. This allows for tracking of these images and image objects for marketing purposes if the printer is a publicly accessible printer (for example, at a promotional kiosk or at a copy center). This would also allow for charging a vendor for advertising space on a finished document page on a per print basis or for image licensing purposes/charging copyright royalties for the images and sub-images on a per use basis.

Embodiments of the present invention may include a set of computer-readable instructions stored on a computer-usable medium for execution by a processor to perform methods herein disclosed. Examples of computer-usable medium include removable and non-removable magnetic media, optical media, dynamic random-access memory (DRAM), static random-access memory (SRAM), read-only memory (ROM) and electrically-erasable and programmable read-only memory (EEPROM or Flash).

It is noted that although the invention was described with specific reference to image database/image repository applications and apparatus it may be adapted for use with other imaging processes and applications and should be apparent to those skilled in the art with the benefit of the present disclosure.

### CONCLUSION

Methods and apparatus have been described for utilizing embedded data layers in images. In one embodiment, an image database stores and controls images and/or image objects and their associated information metadata layers which allows for multiple levels of data to be encoded and retrieved, increasing image data content and information in a manner that will not be separated from the image. Embodiments of the present invention utilize image databases or repositories to store and control images and/or image objects and their associated information metadata layers until their use in multiple transform or high coding rate watermarks, embedding the multiple metadata data fields in the selected image or selected objects (the component images). The various embodiments include databases that allow images or image objects and their associated information to be easily linked and then retrieved on demand or assembled as needed. In one embodiment, a manufacturer generates a database of product images and associated product information. In another embodiment, a database of images and associated information is accessed over a network. In yet another embodiment, the database is distributed by the database producer and is accessed locally by the advertiser/printer/publisher. In another embodiment, a database includes images with two or more data fields for embedding into two or more watermarks of differing encoding or within the same watermark at a high coding rate. In addition, in other embodiments, a database includes two or more data fields for embedding within one or more sub-images/objects of an image. Methods and apparatus are also included for encoding and decoding the multiple data fields.

Although specific embodiments have been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. Accordingly, this application is intended to cover any adaptations or variations of the invention. It is manifestly intended that this invention be limited only by the following claims and equivalents thereof.

1. An image database, comprising:
a database of one or more advertising images, each image having a plurality of associated layers of metadata.

2. The image database of claim 1, wherein the database is adapted to associate the layers of metadata with each image dynamically.

3. The image database of claim 2, wherein the database is adapted to dynamically associate the layers of metadata with one or more images in response to one of a user ID of the image requester, a location input, a business relationship characteristic of the image requester, a promotion type input, and a language input.

4. The image database of claim 1, wherein the database is adapted to selectively update the images and/or associated layers of metadata in response to vendor input.

5. The image database of claim 1, wherein the database is adapted to search the images and/or associated layers of metadata in response to one of a query input by a user, a user ID of the image requester, a location, a business relationship, a promotion type, and a language input.

6. A method of operating a database of advertising images, comprising:
selecting an advertising image; and
selecting two or more layers of metadata associated with the selected image.

7. The method of claim 6, wherein selecting an advertising image further comprises selecting an advertising image in response to a query by one of an advertiser and a publisher.

8. The method of claim 6, wherein selecting two or more layers of metadata associated with the selected image further comprises selecting two or more pre-generated layers of metadata associated with the selected image.

9. The method of claim 6, wherein selecting two or more layers of metadata associated with the selected image further comprises selecting two or more dynamically generated layers of metadata.

10. The method of claim 9, selecting two or more dynamically generated layers of metadata further comprises selecting two or more dynamically generated layers of metadata utilizing one of a user ID of an image requestor, a location input, a business relationship characteristic of an image requester, a promotion type, and a language type.

11. The method of claim 6, further comprising:
updating the selected advertising image and two or more layers of metadata in the database utilizing input from a vendor.

12. A method of operating an advertising image repository, comprising:
selecting an advertising image and two or more layers of metadata associated with the selected image from the advertising image repository.

13. The method of claim 12, wherein selecting an advertising image and two or more layers of metadata associated with the selected image from the advertising image repository further comprises selecting an advertising image and two or more layers of pre-generated metadata associated with the selected image from the advertising image repository.

14. The method of claim 12, wherein selecting an advertising image and two or more layers of metadata associated with the selected image from the advertising image repository further comprises selecting an advertising image and two or more layers of dynamically generated metadata associated with the selected image from the advertising image repository.

15. The method of claim 14, selecting two or more dynamically generated layers of metadata further comprises selecting two or more dynamically generated layers of metadata utilizing one of a user ID of an image requester, a location input, a business relationship characteristic of an advertiser, a promotion type, and a selected language.

16. The method of claim 12, further comprising:
updating the selected advertising image and two or more layers of metadata in the advertising image repository utilizing a changed image or metadata from a vendor.

17. A computer-usable medium having computer-readable instructions stored thereon for execution by a processor to perform a method comprising:
selecting an advertising image from a repository; and
selecting two or more layers of metadata associated with the selected image from the repository.

18. The computer-usable medium of claim 17, wherein selecting an image from a repository further comprises selecting an advertising image from a database.

19. The computer-usable medium of claim 17, wherein selecting two or more layers of metadata associated with the selected image from the repository further comprises selecting two or more pre-generated layers of metadata associated with the selected image.

20. The computer-usable medium of claim 17, wherein selecting two or more layers of metadata associated with the selected image from the repository further comprises selecting two or more dynamically generated layers of metadata.

21. A method of embedding information on alternative items in an image picturing a desired item, comprising:
generating a list of alternative items for the desired item; and
encoding the list of alternative items in a watermark containing two or more layers of data in the image of the desired item.

22. The method of claim 21, wherein generating a list of alternative items for the desired item further comprises generating a list of alternative items, where the list of alternative items includes available variations of the desired item in one of sizes, colors, and item features.

23. The method of claim 21, wherein generating a list of alternative items further comprises generating a list of alternative items, where at least one alternative item is an accessory for the item.

24. A method of accessing one or more layers of data encoded in an image by geographic location, comprising:
decoding a watermark containing two or more layers of data with a reader; and
selecting a subset of the two or more data layers to view based on the geographic location of the reader.

25. The method of claim 24, wherein selecting a subset of the two or more data layers to view based on the geographic location of the reader further comprises executing a process based on the geographic location of the reader, where the process is one of accessing the internet, accessing a database, and accessing a program.

26. The method of claim 24, wherein selecting a subset of the two or more data layers to view based on the geographic location of the reader further comprises selecting a subset of the two or more data layers to view based on the geographic location of the reader, where the geographic location is input by one of a user input, a global positioning (GPS) receiver, a time zone, and a language selection.

27. A method of charging for publication, comprising:
embedding two or more layers of associated metadata in an image provided by a client;
printing the image in a publication; and
charging the client for the publication.

28. The method of claim 27, wherein charging the client for the publication further comprises charging the client for the publication based on a total size of the image.

29. The method of claim 27, wherein charging the client for the publication further comprises charging the client for the publication based on whether the image of the client is a primary subject of the publication.

30. The method of claim 29, wherein charging the client for the publication based on whether the image of the client is a primary subject of the publication further comprises charging the client for the publication based on whether the image of the client is a primary subject of a page of the publication.

31. A method of sharing the costs for a publication, comprising:
embedding two or more layers of associated metadata in one or more images provided by a plurality of advertisers;
printing the images in a publication; and
distributing the cost of the publication within the plurality of advertisers.

32. The method of claim 31, wherein printing the images in a publication further comprises printing the images in an advertisement.

33. The method of claim 31, wherein distributing the cost of the publication within the plurality of advertisers further comprises distributing the cost of the publication equally within the plurality of advertisers.

34. The method of claim 31, wherein distributing the cost of the publication within the plurality of advertisers further comprises distributing the cost of the publication prorated by a total size of one or more images of each advertiser in the publication.

35. The method of claim 31, wherein distributing the cost of the publication within the plurality of advertisers further comprises distributing the cost of the publication within the plurality of advertisers based on whether one or more images of a selected advertiser are the primary subject of the publication.

36. The method of claim 35, wherein distributing the cost of the publication within the plurality of advertisers based on whether one or more images of a selected advertiser are the primary subject of the publication further comprises distributing the cost of the publication within the plurality of advertisers based on whether one or more images of a selected advertiser are the primary subject of a page of the publication.

37. A method of operating a printer, comprising:
receiving a print job containing one or more images, each image having a plurality of layers of associated metadata; and
logging the use of each image as it is printed on a print medium.

38. The method of claim 37, wherein logging the use of each image as it is printed on a print medium further comprises logging the printing use of each image and one or more layers of metadata.

39. The method of claim 37, wherein logging the use of each image as it is printed on a print medium further comprises logging a size of each image on the print medium.

40. The method of claim 37, further comprising:
charging image licensing fees and/or royalties to a client based on the number of times an image is logged at the printer.

41. The method of claim 37, further comprising:
charging advertising fees to one or more vendors based on the number of times an image is logged at the printer.

42. A method of defining multiple layers of metadata for a watermark in an image, comprising:
generating a raster scan of an image with two or more layers of metadata encoded into a watermark, wherein the watermark is one of a high coding rate watermark and a watermark containing a plurality of sub-watermarks, each sub-watermark encoded with a different encoding method and/or transform; and
encoding the raster scan into a page description language (PDL) definition.

43. The method of claim 42, wherein the page description language (PDL) is one of PCL5, PCL6, and Postscript.

44. The method of claim 42, wherein encoding the raster scan into a page description language (PDL) definition further comprises encoding one or more raster scans into a page description language (PDL) definition, wherein at least one raster scan encodes two or more layers of metadata encoded into a watermark.

45. A computer-usable medium having computer-readable instructions stored thereon for execution by a processor to perform a method comprising:
generating a raster scan of an image with two or more layers of metadata encoded into a watermark, wherein the watermark is one of a high coding rate watermark and a watermark containing a plurality of sub-watermarks, each sub-watermark encoded with a different encoding method and/or transform; and
encoding the raster scan into a page description language (PDL) definition.
